(19) United States
(12) Patent Application Publication
(10) Pub. No.: US 2011/0298380 A1
(43) Pub. Date: Dec. 8, 2011

(54) REPORT SYSTEM AND METHOD USING LIGHT-EMITTING DIODE LAMP

(75) Inventor: Wen-Kuei TSAI, Taipei (TW)

(73) Assignee: Top Energy Saving System Corp., NEW TAIPEI CITY (TW)

(21) Appl. No.: 13/210,770

(22) Filed: Aug. 16, 2011

Related U.S. Application Data
(63) Continuation-in-part of application No. 12/416,089, filed on Mar. 31, 2009.
Application No. 12/416,089 is a continuation-in-part of application No. 11/839,498, filed on Aug. 15, 2007, now abandoned.

(30) Foreign Application Priority Data
Jul. 30, 2007 (TW) 096212444

(51) Int. Cl. H05B 37/02

(52) U.S. Cl. 315/150

(57) ABSTRACT

Report systems and methods using light-emitting diode lamps are disclosed. The report systems and methods feature in that a local geographic information is measured, a light with a color temperature indicating the local geographic information is emitted, and the color temperature is reported.

### CROSS-REFERENCE TO RELATED APPLICATION

This is a continuation-in-part application of and claims the priority benefit of pending U.S. patent application Ser. No. 12/416,089, filed on Mar. 31, 2009, entitled “LIGHT EMITTING DIODE LAMP,” which is a continuation-in-part application of abandoned U.S. patent application Ser. No. 11/839,498, filed on Aug. 15, 2007, entitled “LIGHT EMITTING DIODE LAMP,” which claims the priority benefit of Taiwan patent application Ser. No. 96212444, filed on Jul. 30, 2007. The entire contents of the above-mentioned patent applications are hereby incorporated by reference and made a part of this specification.

### BACKGROUND OF THE INVENTION

1. Field of the Invention

The present invention relates to light-emitting diode (LED) lamps and related methods and systems using the lamps.

2. Description of Related Art

Light-emitting diodes (LED) chips are mainly comprised of a compound semiconductor material containing III-V group chemical elements, such as GaN, GaP, GaAs, or the likes. The compound semiconductor is powered to release excessive energy through the combination of electrons and holes, so as to emit photons or light.

Light-emitting diodes have advantages of long lifetime, quick response, small volume, low pollution, high reliability, energy-saving, and easy to made. Its lifetime can reach to 100,000 hours or more, and its response speed can be approximately 10⁻⁹ seconds or less. Due to the advantages, light-emitting diodes have been intensively used in many fields, for example, used as light source, illumination device in large-scale bulletin boards, traffic lights, and so forth.

The brightness and efficiency of light-emitting diodes are continuously improved, and large scale of production has been achieved. Typically, a light-emitting diode lamp emits a light with a constant color temperature, which is only suitable for a particular situation. For example, a white light-emitting diode with higher color temperature is suitable for a working place, and a white light-emitting diode with lower color temperature is suitable for a living environment.

A need is therefore arisen that a light-emitting diode lamp can emits a light with different color temperature for different situations and affairs.

### SUMMARY OF THE INVENTION

This invention is directed to report systems or methods using light-emitting diode lamps.

An embodiment of this invention discloses a report system comprising a managing center and one or more monitoring units. Each monitoring unit comprises a light-emitting diode lamp and a sensor, the sensor measures a local geographic information, the light-emitting diode lamp emits a light with a color temperature indicating the local geographic information, and the color temperature is reported to the managing center.

Another embodiment of this invention discloses a report method comprising the steps of: sensing a local geographic information;

emitting a light with a color temperature indicating the local geographic information; and reporting the color temperature.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of an LED lamp according to an embodiment of this invention.

FIGS. 2A to 2D are block diagrams of an LED lamp according to embodiments of this invention.

FIG. 3 is a block diagram of a report system and method according to an embodiment of this invention.

FIG. 4 is a block diagram of a monitoring unit of FIG. 3 according to an embodiment of this invention.

FIG. 5 to FIG. 8 are block diagrams of a monitoring unit of FIG. 3 according to some embodiments of this invention.

FIG. 9 to FIG. 10 show applications of the report system and method according to embodiments of this invention.

### DESCRIPTION OF EMBODIMENTS

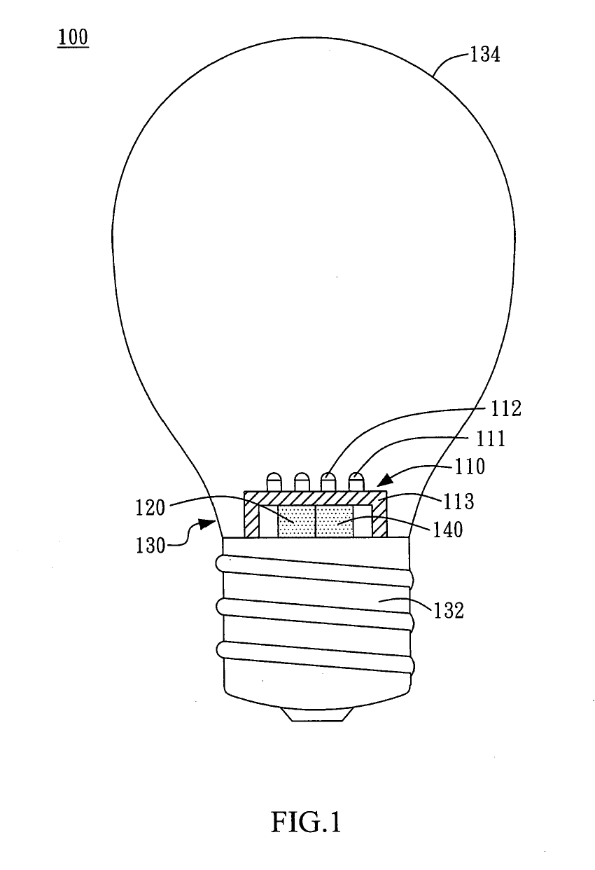

FIG. 1 is a schematic cross-sectional view of an LED lamp according to an embodiment of this invention. Referring to FIG. 1, the LED lamp 100 includes a lamp body 130, a current control circuit 120, a color temperature management unit 140 electrically connected to the current control circuit 120, and an LED array 110 disposed inside the lamp body 130. The LED array 110 electrically connects with the current control circuit 120 and is capable of providing a light having different color temperatures. The current control circuit 120 drives the LED array 110 according to an output of the color temperature management unit 140 automatically. In a preferred embodiment, the LED array 110 includes a carrier 113, a plurality of first LEDs 111, and a plurality of second LEDs 112. The first LEDs 111 are disposed on the carrier 113 for emitting a first light. The second LEDs 112 are disposed on the carrier 113 for emitting a second light. It should be noted that the first light and the second light emitted by the first LEDs 111 and the second LEDs 112 have substantially the same color but different color temperatures.

The LED lamp 100 may be different types, such as light bulbs, spot lights, and the likes. For example, the lamp body 130 of the LED bulb may comprise an electrode portion 132 and a lampshade 134 physically connected to each other, as shown in FIG. 1. The LED array 120 is disposed inside the lampshade 134, and electrically connects to the electrode portion 132.

The lampshade 134 may be made of glass or plastic material that allows the light to pass through and uniformly diffuse the light. In addition, the profile of the electrode portion 132 may be adapted to a bulb socket, so as to conduct power to the LED array 110. Notice that the profile of the LED lamp 100 is drawn for illustration purposes only; it should not be limited.

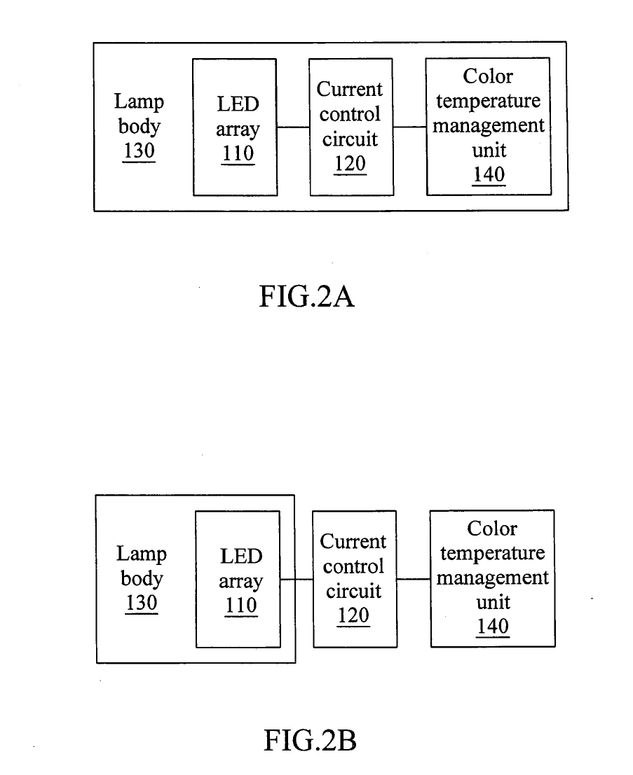

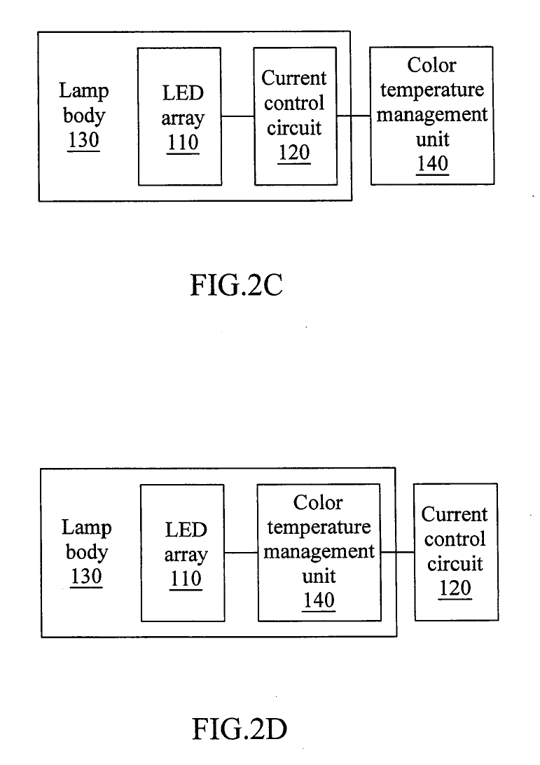

FIGS. 2A to 2D are block diagrams of an LED lamp according to embodiments of this invention. Referring to FIGS. 2A to 2D, due to different requirements, the current control circuit 120 and the color temperature management unit 140 may be disposed inside the lamp body 134 or outside the lamp body 134.

FIG. 2A shows that both of the current control circuit 120 and the color temperature management unit 140 are disposed inside the lamp body 134. In this case, the current control circuit 120 and the color temperature management unit 140 may be integrated on the LED array 110. For example, the current control circuit 120 and the color temperature management unit 140 may be fabricated into an integrated circuit (IC). Then, the integrated circuit IC is soldered on the carrier 113, such that the current control circuit 120 and the color temperature management unit 140 electrically connect to the carrier 113, and modulate the driving current for the first LEDs 111 and the second LEDs 112.

FIG. 2B shows that both of the current control circuit 120 and the color temperature management unit 140 are disposed outside the lamp body 134. In this case, the current control circuit 120 and the color temperature management unit 140 may be integrated in traces (circuits) or switches outside the lamp body 134.

FIG. 2C shows that the current control circuit 120 is disposed inside the lamp body 134, while the color temperature management unit 140 is disposed outside the lamp body 134.

FIG. 2D shows that the current control circuit 120 is disposed outside the lamp body 134, while the color temperature management unit 140 is disposed inside the lamp body 134.

In another aspect, debris flow, landslide, tsunami, and major flood are natural disasters due to heavy rainfall on saturated hillslopes, earthquakes, rapid snowmelt, or the works of human kind. The natural disasters kill people and destroy homes, roads, bridges, and other properties.

Warning systems are developed for mitigating the economic and social costs due to the disasters. For example, a debris flow warning systems may issue a warning based on empirical and analytical relations between rainfall and debris flow generation, real time regional monitoring of rainfall data, precipitation forecasts, and delineation of debris flow hazard areas. However, sometimes the warning systems went wrong, and because the communication may be break down, information of the disaster area may lack or fail to report to the government, such as the fire department.

Accordingly, embodiments of this invention provide geographic information report systems and methods, which may be used in, or cooperate with the current warning systems, for better prediction of disasters and post-disaster response.

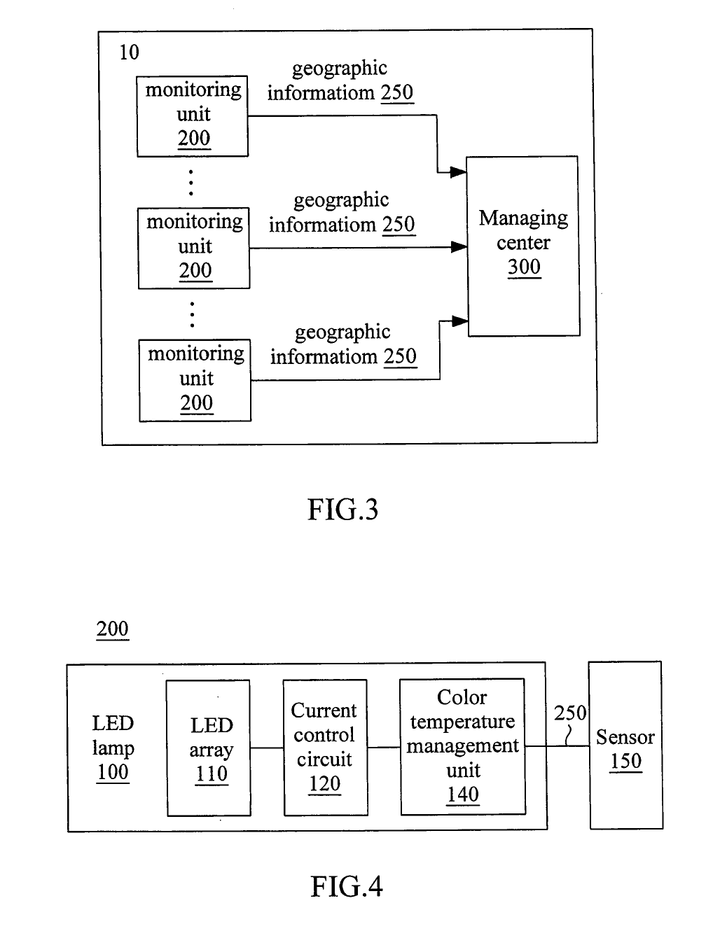

FIG. 3 is a block diagram of a report system and method 10 according to an embodiment of this invention. The report system 10 comprises a managing center 300 and one or more monitoring units 200. Preferably, the number of the monitoring units 200 are plural. In addition, each monitoring unit 200 measures a local geographic information 250 and report it 250 to the managing center 300. The managing center 300 may be a host or a computer of a local government, a department, or an organization. The local geographic information 250 may be reported via a wired communication or a wireless communication. Preferably, the wired communication comprises power line communication (PLC). Preferably, the wireless communication comprises satellite communication, aerial imaging, or satellite imagery. In addition, in this context, the wireless communication may comprise telescope, and the managing center 300 may refer to a remote room or one or more persons.

The local geographic information 250 may comprise one or more of the following: temperature, longitude, latitude, altitude, inclination, atmospheric pressure, humidity, and rainfall amount. The report system and method 10 features in that each monitoring unit 200 emits a light with a color temperature indicating the local geographic information 250. In other words, the managing center 300 may monitor the local geographic information 250 via the color temperatures. In case of the disasters come up in the night, and the normal wired or wireless communications such as network are failed due to the natural disasters, the report system 10 may employ an artificial satellite or a plane or a helicopter to capture images of the monitoring units 200, and the local geographic information 250 of each monitoring unit 200 can be obtained by analyzing its color temperature.

FIG. 4 is a block diagram of a monitoring unit 200 according to an embodiments of this invention. The monitoring unit 200 primarily comprise a light-emitting diode lamp 100 and one or more sensors 150. As discussed in FIGS. 2A to 2D, the current control circuit 120 and the color temperature management unit 140 may be disposed inside or outside of the lamp body 130. The one or more sensors 150 are employed to obtain the local geographic information 250. Various type of sensors known in art, such as temperature gauge, pressure gauge, rain gauge, GPS (global positioning system), inclinometer, and so on, may be employed in this invention.

In addition, the color temperature management unit 140 receives the local geographic information 250 measured by the sensor 150 and transmits it to the current control circuit 120, which then determines the color temperature of the LED array 110 according to the local geographic information 250.

In an embodiment of this invention, the color temperature management unit 140 comprises a power line communication (PLC) module. In another embodiment, the color temperature management unit 140 comprises a wireless communication module receiving the geographic information automatically. The wireless communication module may include, but is not limited to, an IEEE 802.15.4 Zigbee communication module, a Zigbee Pro communication module, or a Z-wave communication module. In another embodiment, the color temperature management unit 140 comprises an optical communication module receiving the geographic information automatically.

Accordingly, the LED lamp 100 emits a light with a color temperature indicating the local geographic information 250 measured by the sensor 150. Referring to FIG. 1 again, the first LEDs 111 and the second LEDs 112 may emit light with different color temperatures, and the color temperature of the LED lamp 100, i.e, the LED array 110, may be changed by respectively changing the drive currents for the first LEDs 111 and the second LEDs 112, and/or changed by controlling the number of the first LEDs 111 and the second LEDs to be lighted. Notice that in this context, the term “and/or” refers to “and” or “or.”

Referring to FIG. 5, the monitoring unit 200 may further comprise power module 160 for supply power to the LED lamp 100 and the sensor 150. Notice that power may be unnecessary for some type of sensor 150, and in another embodiment the sensor 150 has independent power supply. The power module 160 may comprise at least one cell, which is preferably a solar cell.

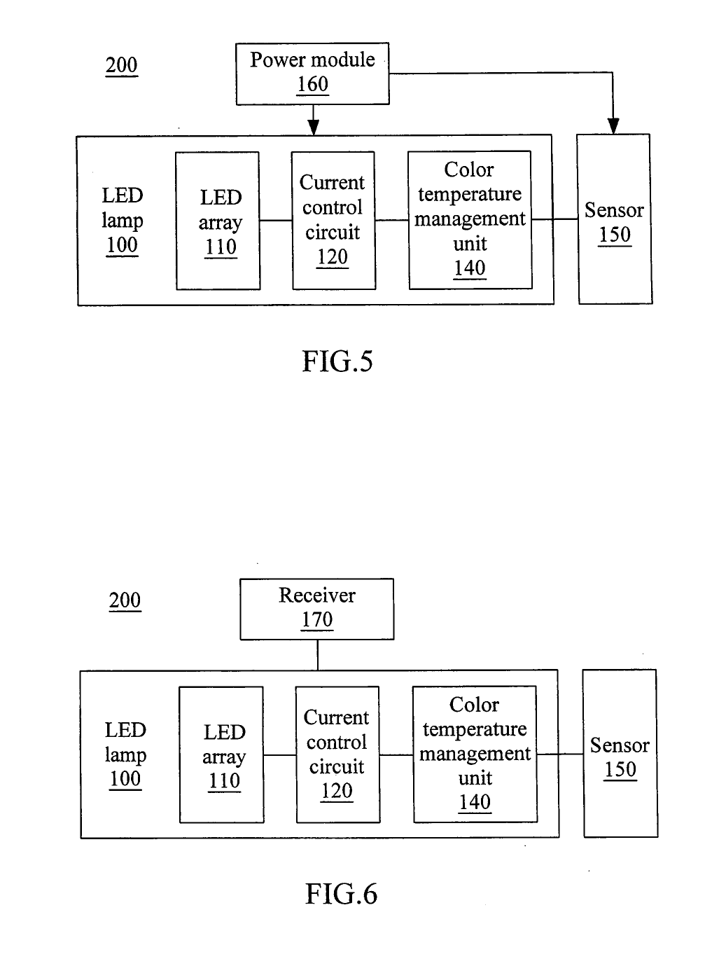

The monitoring unit 200 works around the clock may be unnecessary. Referring to FIG. 6, the monitoring unit 200 may further comprises a receiver 170 for receiving signal from the managing center 300, and the monitoring unit 200 only starts to work after the receiver 170 receives an instruction issued by the managing center 300. The wireless communication as mentioned above is preferably used to transmit the instruction.

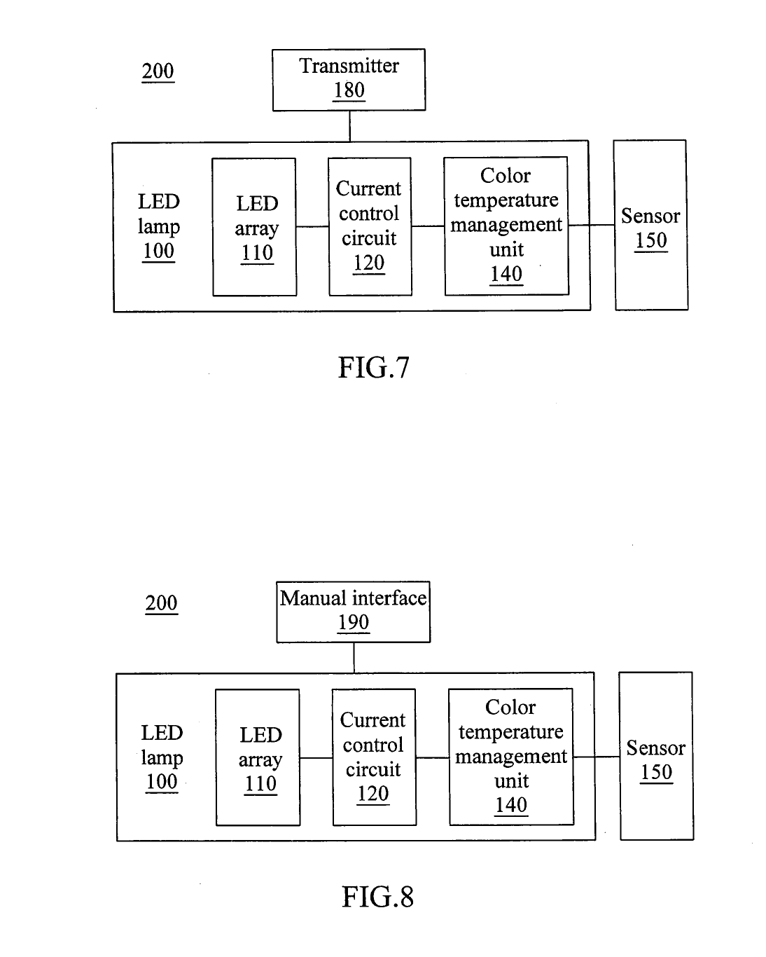

Referring to FIG. 7, the monitoring unit 200 may further comprise a transmitter 180 for transmitting signal to the managing center 300. If the variation of the monitored local geographic information 250 is more than a threshold value, e.g., the variation of a local elevation is more than 30 cm or more, the transmitter 180 transmits a warning signal to the managing center 300, which may instruct an artificial satellite or a helicopter to capture relative images including the monitoring units 200.

Referring to FIG. 8, for emergency, the monitor unit 200 may further comprise a manual interface 190 connected to the LED lamp 100 for manually modulate the color temperature of the LED lamp 100. The manual interface 190 may include, but is not limited to, one or more switches, one or more buttons, and/or an input device such as a keyboard or a touch panel.

Notice that according to different requirements, the monitor unit 200 may comprise variant combinations of the optional elements shown in FIG. 5 to FIG. 8, i.e., variant combinations of the power module 160, to the receiver 170, the transmitter 180, and the manual interface 190. In addition, the light emitted from the LED lamp 100 may be flashed or over-driven except change the color temperature. The flashed or over-driven light, typically with brighter brightness than normal, may be used in some urgent situations and may be triggered automatically or manually (using the manual interface 190 shown in FIG. 8).

The report system and method 10 of this invention can be used as a warning system, and/or can provide useful information for the post-disaster response.

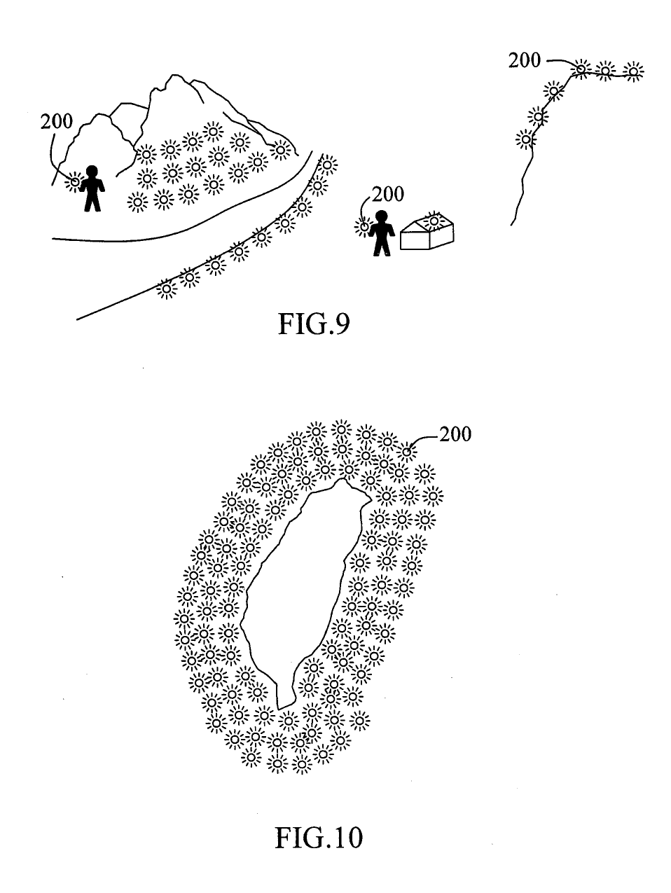

FIG. 9 shows that monitoring units 200 are used as a debris flow/landslide/flood/stray warning and report system. In a particular embodiment, an astray person may employ the monitoring unit 200 with high color temperature and/or flash and/or over-driven brightness, to report her/his location information to the managing center 300, such as the fire department. FIG. 10 shows that monitoring units 200 are used as a tsunami warning and report system. In addition, monitoring units 200 may be used to monitor the temperature of the brine or the position of the iceberg.

The report system and method of this invention have the advantage of low power-consumption. The power needed to emit a light is significantly less than the power needed to emit a satellite signal. In addition, the report system can still work even if in the night and the normal communication has been destroyed.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A report system, comprising:
a managing center; and
one or more monitoring units, wherein each monitoring unit comprises a light-emitting diode lamp and a sensor, the sensor measures a local geographic information, the light-emitting diode lamp emits a light with a color temperature indicating the local geographic information, and the color temperature is reported to the managing center.

2. The report system as recited in claim 1, wherein the local geographic information comprises one or more of the following: a temperature, a longitude, a latitude, an altitude, an inclination, an atmospheric pressure, a humidity, and a rainfall amount.

3. The report system as recited in claim 1, wherein the local geographic information is reported via a wired communication or a wireless communication, and the wired communication comprises power line communication (PLC).

4. The report system as recited in claim 1, wherein the local geographic information is reported via an aerial imaging or a satellite imagery.

5. The report system as recited in claim 1, wherein the local geographic information is reported via a telescope.

6. The report system as recited in claim 1, wherein each monitoring unit further comprises a power module for supplying power to the light-emitting diode lamp, and the power module comprises one or more solar cells.

7. The report system as recited in claim 1, wherein each monitoring unit further comprises a receiver for receiving signal from the managing center, and the monitoring unit only starts to work after the receiver receives an instruction issued by the managing center.

8. The report system as recited in claim 1, wherein each monitoring unit further comprises a transmitter for transmitting signal to the managing center, and if the variation of the local geographic information 250 is more than a threshold value, the transmitter transmits a warning signal to the managing center.

9. The report system as recited in claim 1, wherein each monitoring unit further comprises a manual interface for manually modulating the color temperature of the light-emitting diode lamp, or manually triggering the light-emitting diode to be flashed and/or over-driven.

10. The report system as recited in claim 1, wherein the light is further flashed and/or over-driven automatically in an urgent situation.

11. The report system as recited in claim 1, wherein the light-emitting diode comprises a light-emitting diode array consisted of a first light-emitting diodes and a second light-emitting diodes, and the color temperature is changed by changing drive currents for the first light-emitting diodes and the second light-emitting diodes, and/or changed by controlling the number of the first light-emitting diodes and the second light-emitting diodes to be lighted.

12. A report method, comprising the step of:
sensing a local geographic information;
emitting a light with a color temperature indicating the local geographic information; and
reporting the color temperature.

13. The report method as recited in claim 12, wherein the local geographic information comprises one or more of the following: a temperature, a longitude, a latitude, an altitude, an inclination, an atmospheric pressure, a humidity, and a rainfall amount.

14. The report method as recited in claim 12, wherein the local geographic information is reported via a wired communication or a wireless communication, and the wired communication comprises power line communication (PLC).

15. The report method as recited in claim 12, wherein the local geographic information is reported via an aerial imaging or a satellite imagery.

16. The report method as recited in claim 12, wherein the local geographic information is reported via a telescope.

17. The report method as recited in claim 12, wherein the light is emitted from a light-emitting diode lamp, and a power module comprising one or more solar cells supplies a power to the light-emitting diode lamp.

18. The report method as recited in claim 17, wherein the light-emitting diode lamp only starts to emit the light after receiving an instruction.

19. The report method as recited in claim 12, further comprising reporting a warning signal if the variation of the local geographic information is more than a threshold value.

20. The report method as recited in claim 12, further comprising manually or automatically flashing and/or over-driving the light.
